(19) United States
(12) Patent Application Publication
(10) Pub. No.: US 2010/0055328 A1
(43) Pub. Date: Mar. 4, 2010

(54) COATED SEAMED TRANSFER MEMBER

(75) Inventors: Jin Wu, Webster, NY (US); Jonathan H. Herko, Walworth, NY (US); Scott J. Griffin, Fairport, NY (US); Michael S. Roetker, Webster, NY (US); Dennis J. Prosser, Walworth, NY (US)

Correspondence Address: PATENT DOCUMENTATION CENTER;XEROX CORPORATION, 100 CLINTON AVE SOUTH, MAILSTOP: XRX2-020, ROCHESTER, NY, 14644, US

(73) Assignee: XEROX CORPORATION, Norwalk, CT (US)

(21) Appl. No.: 12/200,147

(22) Filed: Aug. 28, 2008

(51) Int. Cl. B05D 3/00; B05D 3/02

(52) U.S. Cl. 427/294; 427/314

(57) ABSTRACT

An intermediate transfer member wherein the seam on the member is coated with a crosslinked acrylic resin.

### CROSS REFERENCE TO RELATED APPLICATIONS

Illustrated in U.S. Application No. (not yet assigned—Attorney Docket No. 20080579-US-NP) entitled Hydrophobic Carbon Black Intermediate Transfer Components, filed concurrently herewith with the listed individual of Jin Wu, is an intermediate transfer member comprised of a substrate comprising a carbon black surface treated with a fluorinated polymer.

Illustrated in U.S. Application No. (not yet assigned—Attorney Docket No. 20080580-US-NP) entitled Hydrophobic Polyetherimide/Polysiloxane Copolymer Intermediate Transfer Components, filed concurrently herewith with the listed individual of Jin Wu, is an intermediate transfer member comprised of a substrate comprising a polyetherimide polysiloxane copolymer.

Illustrated in U.S. Application No. (not yet assigned—Attorney Docket No. 20080671-US-NP) entitled Coated Transfer Member filed concurrently herewith with the plurality of listed individuals of Jin Wu et al., is a process which comprises providing a flexible belt having a welded seam extending from one parallel edge to the other parallel edge, the welded seam having a rough seam region comprising an overlap of two opposite edges; contacting the rough seam region with a heat and pressure applying tool; and smoothing out the rough seam region with heat and pressure applied by the heat and pressure applying tool to produce a flexible belt having a smooth welded seam, and subsequently coating the belt with a crosslinked acrylic resin.

Illustrated in U.S. application Ser. No. 11/895,255, filed Aug. 22, 2007, the disclosure of which is totally incorporated here by reference, is a process for the post treatment of an ultrasonically welded seamed flexible imaging member belt comprising providing a flexible belt having a welded seam extending from one parallel edge to the other parallel edge, the welded seam having a rough seam region comprising an overlap of two opposite edges; positioning the flexible belt on a lower anvil such that the flexible belt is held in position on the lower anvil by vacuum; contacting the rough seam region with a heat and pressure applying tool; and smoothing out the rough seam region with heat and pressure applied by the heat and pressure applying tool to produce a flexible belt having a smooth welded seam without removing the seam material.

### BACKGROUND

Disclosed are intermediate transfer members, and more specifically, coated seamed intermediate transfer members useful in transferring a developed image in an electrostatographic, for example xerographic, including digital, image on image, and the like, printers, machines or apparatuses. In embodiments, there are selected, for example, seamed intermediate transfer members comprised of a conductive material like carbon black, a polyaniline, or mixtures thereof dispersed in a polymer solution, such as a polyamic acid solution illustrated in copending applications U.S. application Ser. No. 12/129,995, U.S. application Ser. No. 12/181,354, and U.S. application Ser. No. 12/181,409, the disclosures of which are totally incorporated herein by reference; and thereafter, applying a crosslinked acrylic resin to the seam.

Intermediate transfer belts can be generated in the form of seamed belts fabricated by fastening two ends of a web material together, such as by welding, sewing, wiring, stapling, or gluing. While seamless intermediate transfer belts are known, they may require manufacturing processes that render them more costly as compared to similar seamed intermediate transfer belts.

Seamed belts can be fabricated from a sheet cut that originates from an imaging member web. The sheets are generally rectangular or in the shape of a parallelogram where the seam does not form a right angle to the parallel sides of the sheet. All edges may be of the same length or one pair of parallel edges may be longer than the other pair of parallel edges. The sheets are formed into a belt by joining overlapping opposite marginal end regions of the sheet. A seam is typically produced in the overlapping marginal end regions at the point of joining. Joining of the aforementioned areas may be effected by any suitable means, such as by welding, like ultrasonic welding, gluing, taping, pressure heat fusing, and the like.

Ultrasonic welding can be accomplished by retaining in a down position the overlapped ends of a flexible imaging member sheet with a vacuum against a flat anvil surface, and guiding the flat end of an ultrasonic vibrating horn transversely across the width of the sheet, over and along the length of the overlapped ends, to form a welded seam. Ultrasonically welding results in an overlap seam that has an irregular surface topology rendering it difficult for a cleaner blade to remove toner around the seam, and such welding can also cause damage to the cleaner blades by nicking the cleaning edge of the blade. In addition, toner trapping resulting from the poor cleaning and the blade damage causes streaking from the seam and creates an image quality problem. Many post fabrication seam smoothing techniques, which remove material from the seam, may also degrade seam strength.

Also, when ultrasonically welded into a belt, the seam of a multilayered electrophotographic flexible imaging member belt may occasionally contain undesirable high protrusions such as peaks, ridges, spikes, and mounds. These seam protrusions present problems during image cycling of the belt because they interact with the cleaning blade causing blade wear and tear, which can affect cleaning blade efficiency and reduce service life.

In a typical electrostatographic reproducing apparatus, a light image of an original to be copied is recorded in the form of an electrostatic latent image upon a photosensitive member or photoconductor, and the latent image is subsequently rendered visible by the application of electroscopic thermoplastic resin particles and colorant. Generally, the electrostatic latent image is developed by a developer mixture comprised of carrier granules having toner particles adhering triboelectrically thereto, or a liquid developer material, which may include a liquid carrier having toner particles dispersed therein. The developer material is advanced into contact with the electrostatic latent image, and the toner particles are deposited thereon in image configuration. Subsequently, the developed image is transferred to a copy sheet. It is advantageous to transfer the developed image to a coated intermediate transfer web, belt or component, and subsequently transfer with very high transfer efficiency the developed image from the intermediate transfer member to a permanent substrate. The toner image is subsequently usually fixed or fused upon a support, which may be the photoconductor or other support such as plain paper.

In electrostatographic printing machines wherein the toner image is electrostatically transferred by a potential difference between the imaging member and the intermediate transfer member, the transfer of the toner particles to the intermediate transfer member and the retention thereof should be substantially complete so that the image ultimately transferred to the image receiving substrate will have a high resolution. Substantially about 100 percent toner transfer occurs when most or all of the toner particles comprising the image are transferred and little residual toner remains on the surface from which the image was transferred.

Intermediate transfer members allow for a number of advantages such as enabling high throughput at modest process speeds, improving registration of the final color toner image in color systems using synchronous development of one or more component colors using one or more transfer stations, and increasing the variety of final substrates that can be used.

More specifically, a bump, surface irregularity, or other discontinuity in the seam of the belt may disturb the tuck of the cleaning blade as it makes intimate contact with the photoconductive member surface to effect residual toner and debris removal. The increased height differential may allow toner to pass under the cleaning blade, and not be cleaned. Furthermore, seams having differential heights may, when subjected to repeated striking by cleaning blades, cause photoconductive member cycling speed disturbance which adversely affects the crucial photoconductive belt motion quality. Moreover, seams with a bump or any morphological defects can cause the untransferred residual toner to be trapped in the sites of the seam surface irregularities. The seam of a photoreceptor belt, which is repeatedly subjected to the striking action by a cleaning blade under machine functioning conditions, can trigger the development of premature seam delamination failure. In addition, the discontinuity in belt thickness due to the presence of an excessive seam height yields variances of mechanical strength in the belt and reduces the fatigue flex life of the seam when cycling over belt module support rollers. As a result, both the cleaning life of the blade, and the overall service life of the photoreceptor belt can be diminished.

Moreover, the protrusion high spots in the seam may also interfere with the operation of subsystems of copiers, printers and duplicators by damaging electrode wires used in development that position the wires parallel to and closely spaced from the outer imaging surface of belt photoreceptors. These closely spaced wires are employed to facilitate the formation of a toner powder cloud at a development zone adjacent to a toner donor roll and the imaging surface of the belt imaging member.

In operation, an intermediate transfer belt is contacted with a toner image bearing member such as a photoreceptor belt. In the contact zone, an electrostatic field generating device, such as a corotron, a bias transfer roller, a bias blade, or the like, creates electrostatic fields that transfer toner onto the intermediate transfer belt. Subsequently, the intermediate transfer belt is brought into contact with a receiver. An electrostatic field generating device then transfers toner from the intermediate transfer belt to the receiver. Depending on the system, a receiver can be another intermediate transfer member or a substrate onto which the toner will eventually be fixed.

Belts, sheets, films, and the like are of value to the xerographic process. Belt function is often affected by the seam of the belt. For example, belts formed according to known butting or overlapping techniques provide a bump or other discontinuity in the belt surface leading to a height differential between adjacent portions of the belt, for example, of 0.010 inches or more depending on the belt thickness. This increased height differential leads to performance failure.

Thus, there is a need for a seamed member, such as a belt, that avoids or eliminates a number of the above disadvantages, and more specifically, there is a need for an ITB with an improved seam surface topology such that it can withstand dynamic fatigue conditions. For example, an acrylic resin coated seam as disclosed herein provides a smoother surface with substantially decreased or eliminated profile protrusions or irregularities thereby extending its service life. There is also a need for a substantially completely imageable seam, which avoids or minimizes the above disadvantages by overcoating the seam with a polymeric layer, and which layer is mechanically robust and electrically matches the surface resistivity of the seamed intermediate transfer belt (ITB), or intermediate transfer member.

### REFERENCES

Illustrated in U.S. Pat. No. 7,031,647, the disclosure of which is totally incorporated herein by reference, is an imageable seamed belt containing a lignin sulfonic acid doped polyaniline.

Illustrated in U.S. Pat. No. 7,139,519, the disclosure of which is totally incorporated herein by reference, is an intermediate transfer belt, comprising a belt substrate comprising primarily at least one polyimide polymer; and a welded seam.

Illustrated in U.S. Pat. No. 7,130,569, the disclosure of which is totally incorporated herein by reference, is a weldable intermediate transfer belt comprising a substrate comprising a homogeneous composition comprising a polyaniline in an amount of, for example, from about 2 to about 25 percent by weight of total solids, and a thermoplastic polyimide present in an amount of from about 75 to about 98 percent by weight of total solids, wherein the polyaniline has a particle size of, for example, from about 0.5 to about 5 microns.

Puzzle cut seam members are disclosed in U.S. Pat. Nos. 5,487,707, 6,318,223, and 6,440,515.

Illustrated in U.S. Pat. No. 6,602,156 is a polyaniline filled polyimide puzzle cut seamed belt, however, the manufacture of a puzzle cut seamed belt is labor intensive and very costly, and the puzzle cut seam, in embodiments, is sometimes weak. The manufacturing process for a puzzle cut seamed belt usually involves a lengthy in time high temperature and high humidity conditioning step. For the conditioning step, each individual belt is rough cut, rolled up, and placed in a conditioning chamber that is environmentally controlled at about 45° C. and about 85 percent relative humidity, for approximately 20 hours. To prevent or minimize condensation and watermarks, the puzzle cut seamed transfer belt resulting is permitted to remain in the conditioning chamber for a suitable period of time, such as 3 hours. The conditioning of the transfer belt renders it difficult to automate the manufacturing thereof, and the absence of such conditioning may adversely impact the belts electrical properties, which in turn results in poor image quality.

### SUMMARY

According to embodiments illustrated herein, there is provided a flexible intermediate member, such as a belt (ITB), that has an improved surface topology of its welded overlap seam while maintaining seam strength, and processes for the preparation of flexible belts.

In embodiments, there is disclosed a process for the treatment, especially post treatment of an ultrasonically welded seamed flexible imaging member belt comprising providing a flexible belt having a welded seam extending from one parallel edge to the other parallel edge, the welded seam having a rough seam region comprising an overlap of two opposite edges; positioning the flexible belt on a lower anvil such that the flexible belt is held in position on the lower anvil by a vacuum; contacting the rough seam region with a heat and pressure applying tool; and smoothing out the rough seam region with heat and pressure being applied by the heat and pressure applying tool to produce a flexible belt having a smooth welded seam without removing seam material; and then subsequently coating the seam with a crosslinked, such as a self crosslinking, acrylic resin; and an intermediate transfer member, such as an intermediate transfer belt, comprised of a seamed substrate, and wherein the seam is coated with a crosslinked acrylic resin.

Embodiments illustrated herein also provide a process for the post treatment of an ultrasonically welded seamed flexible imaging member belt comprising providing a flexible belt having a welded seam extending from one parallel edge to the other parallel edge, the welded seam having a rough seam region comprising an overlap of two opposite edges; positioning the flexible belt on a lower anvil such that the flexible belt is held in position on the lower anvil by a vacuum; contacting the rough seam region with a heat and pressure applying tool, the heat and pressure applying tool being selected from the group consisting of an ultrasonic vibrating horn, an automated heated pressure roller and a heated upper anvil; smoothing out the rough seam region with heat and pressure to produce a flexible belt having a smooth welded seam; and thereafter overcoating the seam with a crosslinked, such as a self crosslinking, acrylic resin; and a process which comprises providing a flexible belt having a welded seam extending from one parallel edge to the other parallel edge, the welded seam having a rough seam region comprising an overlap of two opposite edges; positioning the flexible belt on a lower anvil such that the flexible belt is held in position on the lower anvil by a vacuum; contacting the rough seam region with a heat and pressure applying tool; and smoothing out the rough seam region with heat and pressure applied by the heat and pressure applying tool to produce a flexible belt having a smooth welded seam, and subsequently coating the entire seam with a crosslinked acrylic resin.

### DETAILED DESCRIPTION

Aspects of the present disclosure relate to a process which comprises providing a flexible belt having a welded seam extending from one parallel edge to the other parallel edge, the welded seam having a rough seam region comprising an overlap of two opposite edges; positioning the flexible belt on the lower portion of an anvil such that the flexible belt is held in position on the lower anvil by a vacuum; contacting the rough seam region with heat and pressure; smoothing out the rough seam region with heat and pressure applied by a known heat and pressure applying device to produce a flexible belt having a smooth welded seam, and subsequently coating the seam with a known crosslinked acrylic resin; an intermediate transfer member comprised of a seamed substrate, and wherein the seam is fully coated with a crosslinked acrylic resin; an intermediate transfer belt comprised of a seamed substrate, and wherein the seam is coated with a self crosslinked acrylic resin; and a polymeric coated seamed member inclusive of flexible belts, fuser belts, pressure belts, intermediate transfer belts, transfuse belts, transport belts, developer belts, photoreceptor belts, and the like.

The coated acrylic resin seamed members, such as belts, can be prepared by a number of processes, such as a process which forms a strength enhancing bond between voids of mutually mating elements. The strength enhancing bond may comprise a material which is chemically and physically compatible with the material of the coating layer or layers of the belt. The resin coated welded seam has a smoother surface topology to thereby improve both the cleaning life of the cleaning blade and the overall service life of the flexible belt. More specifically, embodiments disclosed herein relate to a post treatment process for efficiently and consistently smoothing an ultrasonically welded crosslinked acrylic resin coated overlap seam of a flexible belt that does not degrade seam strength, and where the coating is mechanically robust, and electrically is equal to or about equal to the surface resistivity of the seamed belt.

The coating, which is applied to the member, such as a belt seam, is comprised of an acrylic resin, and more specifically, a self crosslinked acrylic resin, that is for example, where a crosslinking component is avoided, such as the resin DORESCO® TA22-8, available from Lubrizol Dock Resins, Linden, N.J., and substantially free of any conductive components dispersed within. By the addition of a small amount of an acid catalyst, the acrylic resin self crosslinks upon thermal curing at temperatures of, for example, from about 80° C. to about 200° C. for a suitable time period, such as for example, from about 1 to about 60 minutes, and more specifically, curing at about 130° C. for 3 minutes, resulting in a mechanically robust acrylic resin layer with a surface resistivity of from about 10⁹ to about 10¹³ ohm/sq, and specifically about 10¹¹ ohm/sq. While the percentage of crosslinking can be difficult to determine, and not being desired to be limited by theory, the acrylic resin layer is crosslinked to a suitable value, such as for example, from about 30 to about 100 percent, and from about 50 to about 95 percent.

In embodiments, examples of the self crosslinking resin selected for coating the seam include a self crosslinking acrylic resin with, for example, a weight average molecular weight (M_{w}) of from about 100,000 to about 500,000, or from about 120,000 to about 200,000; a polydispersity index (PDI) (M_{w}/Mₙ) of from about 1.5 to about 4, or from about 2 to about 3; and a bulk resistivity (at, for example, 20° C. and 50 percent humidity) of from about 10⁸ to about 10¹⁴ Ωcm, or from about 10⁹ to about 10¹² Ωcm. A specific example of a self crosslinking acrylic resin selected for coating the belt seam includes DORESCO® TA22-8, obtained from Lubrizol Dock Resins, Linden, N.J., which resin in one form possesses, it is believed, a weight average molecular weight of about 160,000, a polydispersity index of about 2.3, and a bulk resistivity (20° C. and 50 percent humidity) of about 10¹¹ Ωcm.

Other examples of the self crosslinking acrylic resin selected for coating the seam include DORESCO® TA22-51, obtained from Lubrizol Dock Resins, Linden, N.J., which resin possesses lower crosslinking density upon thermal cure when compared with DORESCO® TA22-8 resin.

The thickness of the acrylic resin coating on the seam can vary; for example, this thickness can be from about 1 to about 15, from about 1 to about 10, from about 1 to about 6, and from about 1 to about 3, and yet more specifically 3 microns.

When the entire seam is overcoated, the width of the acrylic resin coating on the seam can vary; for example, this width can be from about 1 to about 20, from about 1 to about 10, and yet more specifically, 6 centimeters.

The circumference of the transfer member in a film or belt configuration of from 1 to 2 or more layers is, for example, from about 250 to about 2,500, from about 1,500 to about 2,500, or from about 2,000 to about 2,200 millimeters. The width of the film or belt is, for example, from about 100 to about 1,000, from about 200 to about 500, or from about 300 to about 400 millimeters. The thickness of the film or belt is, for example, from about 25 to about 500, or from about 50 to 150 microns.

Nonlimiting examples of catalysts selected for the polymeric acrylic resin overcoat layer include oxalic acid, maleic acid, carboxylic acid, ascorbic acid, malonic acid, succinic acid, tartaric acid, citric acid, p-toluenesulfonic acid, methanesulfonic acid, and the like, and mixtures thereof. A typical concentration of acid catalyst is from about 0.01 to about 5, about 0.5 to about 4, and about 1 to about 3 weight percent based on the weight of the crosslinked acrylic resin.

A blocking agent can also be included in the overcoat layer, which agent can “tie up” or substantially block the acid catalyst effect to provide solution stability until the acid catalyst function is initiated. Thus, for example, the blocking agent can block the acid effect until the solution temperature is raised above a threshold temperature. For example, some blocking agents can be used to block the acid effect until the solution temperature is raised above about 100° C. At that time, the blocking agent dissociates from the acid and vaporizes. The unassociated acid is then free to catalyze the polymerization. Examples of such suitable blocking agents include, but are not limited to, pyridine and commercial acid solutions containing blocking agents, such as CYCAT® 4045, available from Cytec Industries Inc. Examples of additional components present in the intermediate transfer member include a number of known conductive components and polymers, such as polyanilines. In embodiments, the polyaniline component has a relatively small particle size of, for example, from about 0.5 to about 5, from about 1.1 to about 2.3, from about 1.2 to about 2, from about 1.5 to about 1.9, or about 1.7 microns.

Specific examples of polyanilines selected for the transfer member, such as an ITB, are PANIPOL™ F, commercially available from Panipol Oy, Finland; and lignosulfonic acid grafted polyaniline, represented by

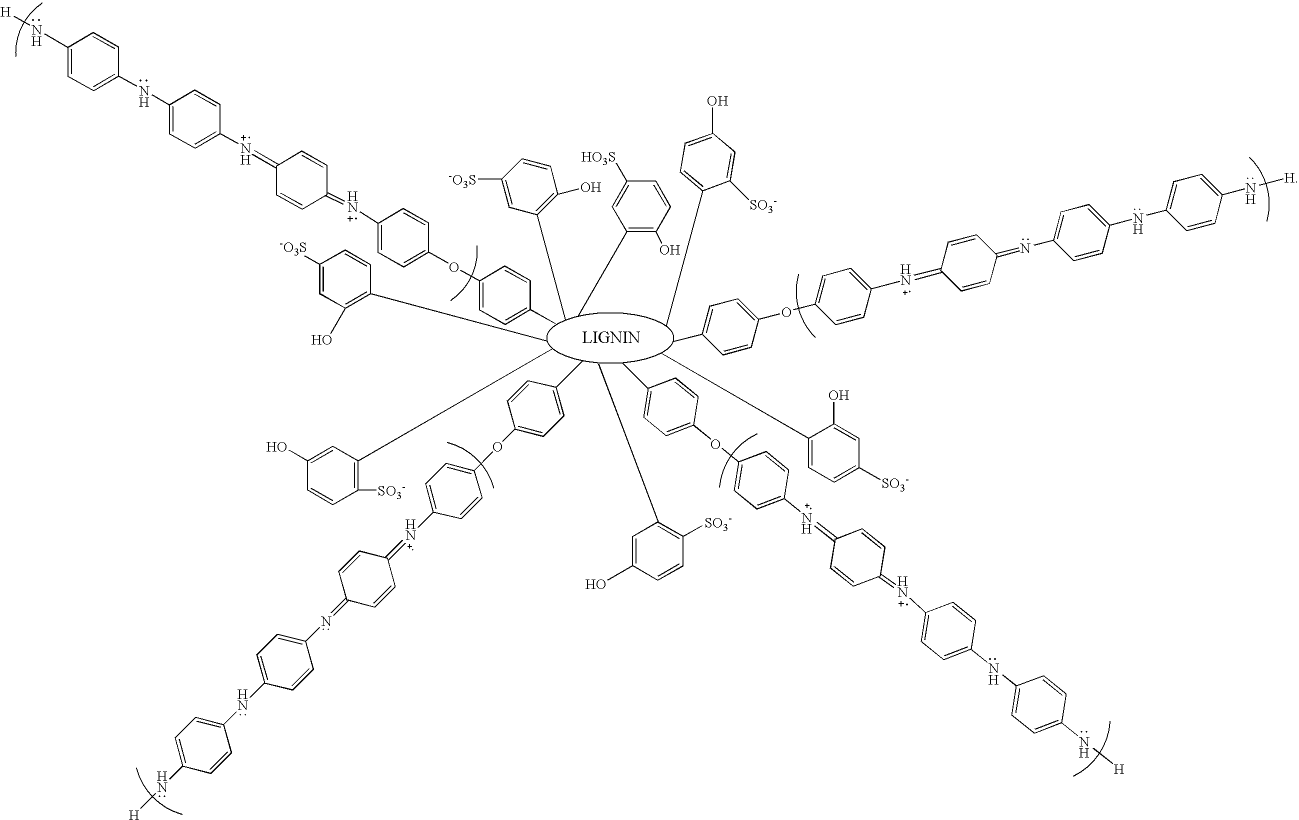

The end marginal regions of the transfer member can be joined by any suitable means including gluing, taping, stapling, pressure, and heat fusing to form a continuous member such as a belt, sleeve, or cylinder. Both heat and pressure can be used to bond the end marginal regions into a seam in the overlap region. The flexible member is thus transformed from a sheet of an intermediate transfer material into a continuous intermediate transfer belt. The flexible member has a first exterior major surface or side, and a second exterior major surface or side on the opposite side. The seam joins the flexible member so that the bottom surface, generally including at least one layer immediately above, at and/or near the first end marginal region is integral with the top surface, generally including at least one layer immediately below, at and/or near the second end marginal region.

A heat and pressure seam joining means includes ultrasonic welding to transform the sheet of an intermediate transfer material into an intermediate transfer belt. The belt can be fabricated by ultrasonic welding of the overlapped opposite end regions of a sheet. In the ultrasonic seam welding process, ultrasonic energy applied to the overlap region is used to melt suitable layers.

Ultrasonic welding is selected, in embodiment, for joining the flexible intermediate transfer member because it is rapid, clean and solvent free, and of low cost, and it produces a thin and narrow seam. In addition, ultrasonic welding is selected since the mechanical high frequency pounding of the welding horn causes the generation of heat at the contiguous overlapping end marginal regions of the flexible imaging sheet loop to maximize melting of one or more layers therein to form a strong and precisely defined seam joint. For example, ultrasonic welding, and an apparatus for performing the same is disclosed in U.S. Pat. No. 4,532,166, the disclosure of which is totally incorporated herein by reference.

In a specific embodiment, the heat and pressure applying tool is an ultrasonic vibrating horn. In such an embodiment, the lower anvil selected may be a flat anvil. This tool smoothes out the rough seam region by proceeding with a second welding pass across the welded region such that the rough seam region is further compressed under high pressure and heat. Since the post treatment smoothing process uses the welding horn to further compress the overlap, rather than removing the protruding material, seam strength is not substantially degraded. Moreover, the welded seam may be double welded from the back side of the seam as well. In such embodiments, the second welding pass is accomplished with the seam inverted on the anvil so that the imaging side of the belt is facing down on the anvil. In this manner, the overlap on the image side of the belt can be substantially eliminated as it conforms to the smooth surface of the anvil.

The heat and pressure applying tool is, in embodiments, an automated heated pressure roller or a heated upper anvil. In these embodiments, the lower anvil is a round anvil, and an edge of the seam region is positioned on an apex of the lower anvil, and where a smooth seam with no protrusion results by traversing the automated heated pressure roller along the seam to reform the edge of the seam region. The heated pressure roller applies pressure on the welded seam against the lower anvil while heating the seam such that a smooth welded seam is produced with the belt held in place by a vacuum on the lower anvil while the heated pressure roller traverses the seam. To effectively heat roll the seam smooth, the roller to the seam is positioned so as to be located on the apex of the anvil to fully expose the area to be smoothed. The surface of the roller should be tangent to the anvil's apex. Using a round anvil allows heat and pressure to be concentrated along the edge of the overlap. In further embodiments, the heated pressure roller is used in an automated system where the heated roller is affixed to a linear actuator which drives it tangent to the roller's apex along its length. Temperature may be controlled by means of a thermostat controller while pressure may be controlled by spring tension.

By applying the heated upper anvil to the edge of the seam region and where the welded seam is sandwiched between the upper and lower anvils, the welded seam is thus compressed under high pressure. Both the upper and lower anvils may be heated so that during the compression, the seam material is also heated close to its glass transition temperature to further facilitate the reformation of the welded seam and to produce a smooth welded seam. The upper and lower anvils may be heated by heating components embedded in the upper and lower anvils, and which are controlled by a thermostatic controller. In this embodiment, the welded seam may be reduced in seam thickness by from about 25 percent to about 35 percent.

The following Examples are provided.

### COMPARATIVE EXAMPLE 1

A seamed intermediate transfer belt was prepared as follows. A 3 mil intermediate transfer sheet comprised of a mixture of 91 weight percent of KAPTON® KJ (available from E.I. DuPont) and 9 weight percent of polyaniline (1.7 microns in diameter size) was cut to a size of 362 millimeters wide by 2,210.8 millimeters long. The ends were overlapped by 300 microns and an ultrasonic horn was used to compress the above mixture against a steel welding platen, melting the mixture in the overlap region, and creating a seam. The seam was then reverse welded, followed by smoothing the double-welded seam with sand paper, resulting in a seam of about 100 microns thick.

### EXAMPLE I

The Comparative Example 1 seamed ITB was overcoated, by a known draw bar coating method, with a polymeric layer solution of about 3 microns thick and 6 centimeters wide. The overcoating solution, which was comprised of the self crosslinking acrylic resin, DORESCO® TA22-8, obtained from Lubrizol, and the p-toluenesulfonic (PTSA) acid catalyst in a ratio of 99/1 in an ethanol/acetone/isopropanol solvent mixture, about 20 weight percent solids, was coated by the known draw bar coating process, resulting in an overcoat area of about 6 centimeters wide covering the seam in the middle. The overcoated seam was thermally cured at 130° C. for 3 minutes with minimal perturbation, that is no disruption, or disorder in the ITB itself.

The surface resistivity of the above overcoat, which was measured using a High Resistivity Meter (Hiresta-Up MCP-HT450 available from Mitsubishi Chemical Corp., under 1,000V, averaging four measurements at varying spots, 72° F./22 percent room humidity), was 3.68×10¹¹ ohm/sq, similar to that of the Comparative Example 1 transfer belt.

The overcoated seamed ITB of Example I and the noncoated seamed ITB of Comparative Example 1 were print tested on a Xerox Corporation DC8000 printer. After 100 prints, full page image quality analysis of 50 percent of the halftone images were visually evaluated (Table 1), especially around the overcoated seam areas.

TABLE 1

| Image Evaluation | Printed Overcoated | Printed Overcoated |
|---|---|---|
| After 100 Prints | Seam Area | Non-Seam Area |
| Comparative | Seam visible with | Overcoat visible with |
| Example 1 | distinguishable change in | distinguishable change in |
| | halftone quality | halftone quality |
| Example I | Seam invisible with no | Overcoat invisible with no |
| | distinguishable change in | distinguishable change in |
| | halftone quality | halftone quality |

The above data demonstrates that the Example I 100 percent completely acrylic resin overcoated imageable seam layer, 3 μm in thickness, which was sanded by hand, had the advantages indicated. The seams were formed, as illustrated herein, by a first ultrasonic welding, and then turned upside down and welded a second time. Both the overcoated area and the seam were invisible for 100 xerographic prints, while for the Comparative Example 1 ITB noncoated seam, the seam was visible for each of the 100 xerographic prints. The acrylic resin Example I overcoated ITB was mechanically robust, and the seamed region remained invisible for 400,000 prints in contrast to the Comparative Example 1 ITB where the seamed region was visible beginning with the first print, and remained visible for 400,000 prints.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. A process which comprises
providing a flexible belt having a welded seam extending from one parallel edge to the other parallel edge, the welded seam having a rough seam region comprising an overlap of two opposite edges;
contacting the rough seam region with a heat and pressure applying tool; and
smoothing out the rough seam region with heat and pressure applied by the heat and pressure applying tool to produce a flexible belt having a smooth welded seam, and subsequently coating the seam with a crosslinked acrylic resin.

2. A process in accordance with claim 1 wherein said resin is crosslinked at from about 25 to about 95 percent.

3. A process in accordance with claim 1 wherein said resin is crosslinked at from about 40 to about 100 percent.

4. A process in accordance with claim 1 wherein said resin possesses a bulk resistivity at about 20° C., and about 50 percent humidity of from about 10⁸ to about 10¹⁴ Ωcm, a weight average molecular weight (M_{w}) of from about 100,000 to about 500,000, and a polydispersity index (PDI) (M_{w}/Mₙ) of from about 1.5 to about 4.

5. A process in accordance with claim 1 wherein said resin possesses a bulk resistivity of from about 10⁹ to about 10¹² Ωcm, and a weight average molecular weight (M_{w}) of from about 120,000 to about 200,000.

6. A process in accordance with claim 1 wherein the heat and pressure applying tool is selected from the group consisting of an automated heated pressure roller and a heated anvil.

7. A process in accordance with claim 1 wherein prior to contacting the rough seam region the flexible belt is positioned on an anvil, followed by applying a vacuum thereto.

8. A process in accordance with claim 6 wherein the smoothing out of the rough seam region is performed by traversing the automated heated pressure roller along the seam to reform the edge of the seam region such that a smooth welded seam is produced.

9. A process in accordance with claim 6 wherein the heat is controlled by a thermostat controller, and the pressure is controlled by spring tension.

10. A process in accordance with claim 6 wherein the smoothing out of the rough seam region is performed by applying the heated upper part of said anvil to the edge of the seam region such that the welded seam is compressed under high pressure, and heated close to a glass transition temperature of the seam material such that a smooth welded seam is produced.

11. An intermediate transfer member comprised of a seamed substrate, and wherein the seam is coated with a crosslinked acrylic resin.

12. An intermediate transfer member in accordance with claim 11 wherein said substrate includes carbon black and a polyimide.

13. An intermediate transfer member in accordance with claim 11 wherein said substrate is comprised of a polyaniline and a polyimide.

14. An intermediate transfer member in accordance with claim 11 wherein said member is a flexible belt selected from the group consisting of a photoreceptor, an electroreceptor, and an intermediate image transfer belt.

15. An intermediate transfer member in accordance with claim 11 wherein said acrylic resin selected for coating the seam possesses a bulk resistivity at about 20° C., and about 50 percent humidity of from about 10⁸ to about 10¹⁴ Ωcm, a weight average molecular weight (M_{w}) of from about 100,000 to about 500,000, and a polydispersity index (PDI) (M_{w}/Mₙ) of from about 1.5 to about 4.

16. An intermediate transfer member in accordance with claim 11 wherein said acrylic resin possesses a bulk resistivity of from about 10⁹ to about 10¹² Ωcm, a weight average molecular weight (M_{w}) of from about 120,000 to about 200,000, and a polydispersity index (PDI) (M_{w}/Mₙ) of from about 2 to about 3.

17. An intermediate transfer member in accordance with claim 11 further comprising an outer release layer positioned on said substrate.

18. An intermediate transfer member in accordance with claim 17 wherein said release layer comprises a poly(vinyl chloride).

19. An intermediate transfer belt comprised of a seamed substrate, and wherein the seam is coated with a self crosslinked acrylic resin.

20. An intermediate transfer belt in accordance with claim 19 wherein prior to said coating the seam has a roughened surface, and subsequent to said coating the seamed area is smooth.

21. An intermediate transfer belt in accordance with claim 19 wherein there is further included in said coating a catalyst.

22. An intermediate transfer belt in accordance with claim 21 wherein said catalyst is oxalic acid, maleic acid, carboxylic acid, ascorbic acid, malonic acid, succinic acid, tartaric acid, citric acid, p-toluenesulfonic acid, methanesulfonic acid, or mixtures thereof.

23. A process in accordance with claim 1 wherein there is further included a catalyst in the crosslinked acrylic resin, and which catalyst is oxalic acid, maleic acid, carboxylic acid, ascorbic acid, malonic acid, succinic acid, tartaric acid, citric acid, p-toluenesulfonic acid, methanesulfonic acid, or mixtures thereof at a concentration of from about 0.01 to about 5 weight percent based on the weight of the crosslinked acrylic resin.
